(19) United States
(12) Patent Application Publication
(10) Pub. No.: US 2006/0081192 A1
(43) Pub. Date: Apr. 20, 2006

(54) System and method for holding fish

(76) Inventors: Auldin James Massey, Anacortes, WA (US); David Lawrence Davis, Indianola, WA (US)

Correspondence Address: Robert S. Hughes;HUGHES LAW FIRM, PLLC, Pacific Meridian Plaza, 4164 Meridian Street, Suite 302, Bellingham, WA, 98226, US

(21) Appl. No.: 10/970,066

(22) Filed: Oct. 19, 2004

(51) Int. Cl. A01K 61/00; A01K 97/00

(52) U.S. Cl. 119/215; 43/4; 119/200; 269/287; 269/289 R; 269/156

(57) ABSTRACT

A device for holding a fish, for instance, for administering a vaccine to a fish. The fish holding device may include at least two side clamping members configured to engage opposite sides of a fish's belly region. The fish holding device may also include an upper clamping member configured to push downwardly on the back of the fish. The fish holding device may also include a pair of side walls, each of the two side clamping members attached to a respective one of the side walls. Each side clamping member may be pivotably attached to a respective side wall such that bottom edges of the side clamping members are pivotable towards each other.

### GOVERNMENT LICENSE RIGHTS

This invention was made with United States Government support under Cooperative Agreement Number 70NANB1H3026 awarded by the National Institute of Standards and Technology (NIST). The United States Government has certain rights in the invention.

### FIELD OF THE INVENTION

The present invention relates to a system and method for processing fish. More specifically, the present invention relates to a system and method for holding fish for vaccination and other purposes.

### BACKGROUND INFORMATION

In the fields of pisciculture and aquatic resource management, it is often necessary to restrain the movement of a live fish. For instance, it is very common to restrain the movement of a live fish, e.g., for the purpose of vaccinating it. This vaccination procedure helps to reduce the spread of disease and eliminate the use of antibiotics in the fish farming industry. Vaccines that are currently in use typically require placement within the peritoneal cavity of the fish. These vaccines are typically administered through the belly of the fish. Specifically, a needle is used to penetrate the skin, muscle, and peritoneal membrane of the fish and the vaccine is injected into the fluid within the peritoneal cavity. It is desirable that no vaccine is injected into the belly muscle adjacent to the peritoneal membrane. It is also desirable that the needle does not damage any of the internal organs within the peritoneal cavity. These problems can lead to reduction of value or death of the fish.

One method by which fish are held for vaccination is by hand. Another method by which fish are held for vaccination is via fish vaccination machines. However, the use of conventional fish vaccination machines is limited. One reason for this is that these fish vaccination machines are not sufficiently accurate. One of the problems experienced by conventional fish vaccination machines is that the mechanical means employed by them for holding fish do not adequately support the fish's belly wall to facilitate reliable puncture by the needle. Instead, the skin of the fish, which may be tough to penetrate, can be displaced by the needle point. This can lead to a variation in the position of the skin at the time of puncture, which in turn may result in variation in the final positioning of the vaccine. It is possible that in some cases, the needle never penetrates the skin at all.

Some conventional fish vaccination machines hold the fish by pushing against the fish's back with an inverted V which pushes the fish's belly against a flat surface while centering the fish over a hole in the flat surface. The injection needle can then access the fish's belly through the hole in the flat surface. However, in fish vaccination machines of this type, the fish's belly is often pushed away from the hole and is displaced to the sides of the hole. This problem is exacerbated by dull needles and the additional resistance to a needle puncture caused by fish scales.

Other problems experienced by conventional fish vaccination machines is that many fish vaccination machines require a fish to be anesthetized prior to being used, a process which increases the cost and complexity of the fish processing operation and may harm the fish. In addition, the belly muscle of an anesthetized fish is very limp yet the skin is quite tough, increasing the likelihood that a needle will not puncture a fish's belly.

Thus, there is a need for an improved device and method for holding a fish, particularly but not exclusively for the purpose of vaccinating the fish.

### SUMMARY OF THE INVENTION

The above and other beneficial objects of the present invention are achieved by providing a system and method as described herein. The present invention, according to one example embodiment thereof, relates to a device for holding a fish. Advantageously, the fish holding device may be employed to administer a vaccine to a fish, although any other use is also contemplated. The fish holding device may be automatically or manually operated.

The fish holding device may include at least two side clamping members configured to engage opposite sides of a fish's belly region. The fish holding device may also include an upper clamping member configured to push downwardly on the back of the fish. The fish holding device may also include a pair of side walls, each of the two side clamping members attached to a respective one of the side walls. The side walls may be adjustable, and may be arranged either parallel relative to each other or non-parallel relative to each other. Each side clamping member may be pivotably attached to a respective side wall such that bottom edges of the side clamping members are pivotable towards each other.

In various embodiments of the present invention, each side clamping member has a front end and a rear end, wherein the front end of each side clamping member may be higher than, lower than or at the same height as, the rear end of the side clamping member. Also, the side clamping members may be tapered such that the rear end of each side clamping member is wider than, or less wide than, the front end of the side clamping member. Alternatively, the side clamping members may be un-tapered. Advantageously, the side clamping members are flexible so as to conform to the shape of the fish.

In one embodiment, the side clamping members are arranged such that the rear ends of each side clamping member contact each other prior to the front ends of the side clamping member contacting each other, thereby holding the tail end of the fish in a relatively high position and helping to keep the fish upright. Alternatively, the side clamping members are arranged such that the rear ends of each side clamping member contact each other simultaneously to the front ends of the side clamping member contacting each other.

The bottom surface of the fish holding device may have at least one opening through which a needle, e.g., a needle for administering a vaccination, may be inserted. In addition, the fish holding device may include a sensor for sensing when a fish is in position between the side clamping members, and an actuation element for actuating the side clamping members so as to hold a fish that is sensed to be in position between the side clamping members. Furthermore, the actuation element may be configured to actuate the upper clamping member so as to press down on a fish that is sensed to be in position between the side clamping members.

The side clamping members may be configured to hold either an anesthetized or a non-anesthetized fish. For instance, the side clamping members may be static, e.g., in a V- or U-shape, such that a fish may be held therein without the need to pivotably press the side clamping members against the sides of the fish.

### BRIEF DESCRIPTION OF THE DRAWINGS

FIG. 1 is a perspective view of some of the components of a fish holding device, according to one embodiment of the present invention;

FIG. 2 is a rear cross-sectional view of the fish holding device, according to the embodiment of the present invention shown in FIG. 1;

FIG. 3 is a rear cross-sectional view of the fish holding device, according to the embodiment of the present invention shown in FIG. 1; and

FIG. 4 is a side view that illustrates the fish holding device, according to the embodiment of the present invention shown in FIG. 1.

### DETAILED DESCRIPTION

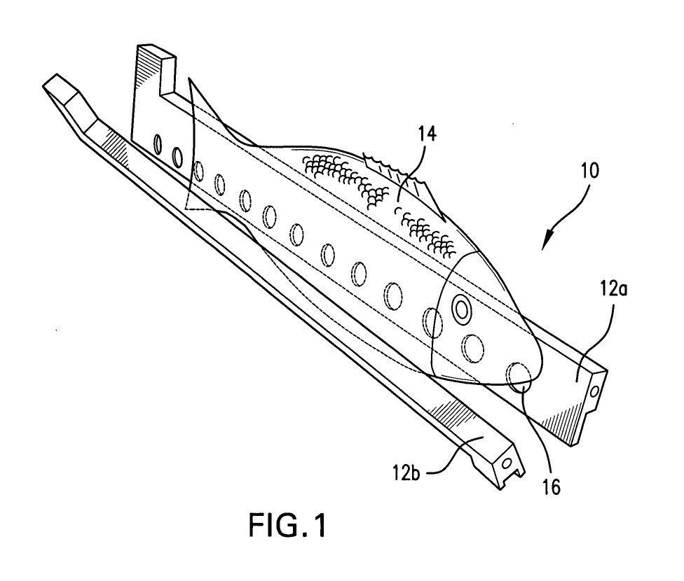

FIG. 1 is a perspective view of some of the components of a fish holding device 10, according to one embodiment of the present invention. FIG. 1 illustrates the fish holding device 10 having two side clamping members 12a and 12b. A fish 14 is held between the two side clamping members 12a and 12b. The two side clamping members 12a and 12b are preferably semi-rigid, e.g., they are rigid enough to firmly hold a fish 14 in place therebetween, but flexible enough to conform somewhat to the shape of the fish 14. Advantageously, the two side members 12a and 12b provide inward pressure against the belly of the fish 14.

Each side clamping member 12a and 12b may have one or more voids 16 for facilitating the flexibility of the side clamping member and for enabling improved flow of water. Advantageously, each side clamping member 12a and 12b is at least as long as the length of the longest fish for which the fish holding device is anticipated to be employed.

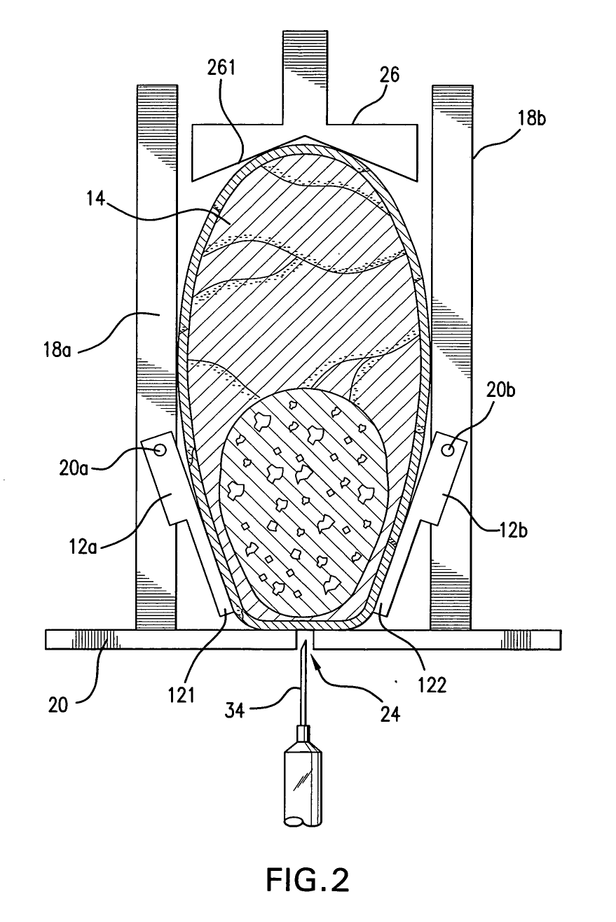

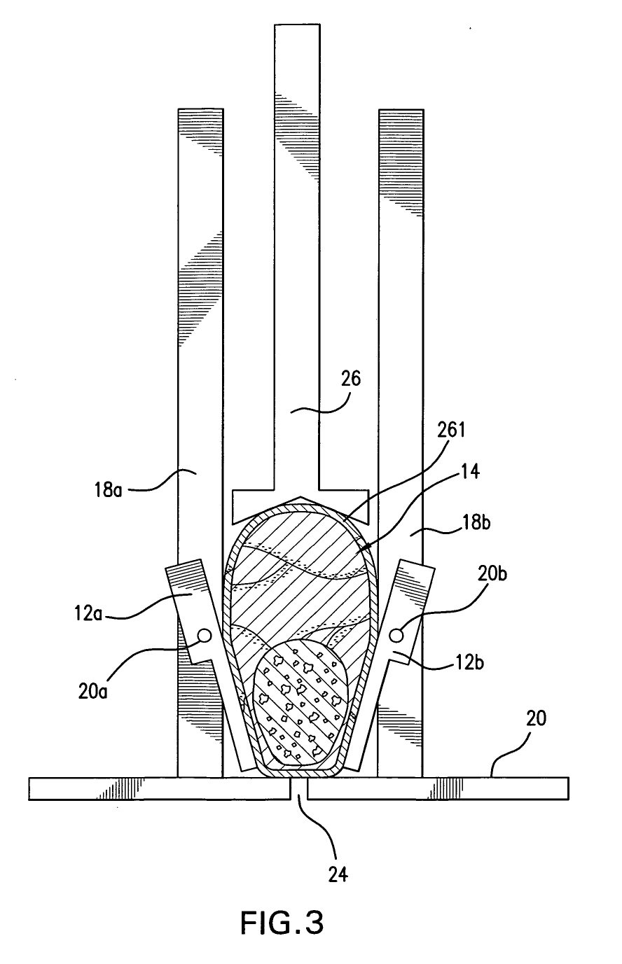

FIGS. 2 and 3 are rear cross-sectional views of the fish holding device 10, according to one embodiment of the present invention, showing additional features thereof. For instance, referring to FIG. 2, the fish holding device 10 includes two side walls 18a and 18b. The side clamping members 12a and 12b are pivotably attached to the side walls 18a and 18b, respectively, such that the bottom ends 121 and 122 of the side clamping members 12a and 12b, respectively, are pivotable towards each other about pivot points 20a and 20b, respectively. The side walls 18a and 18b may be adjustable, e.g., they may be movable so as to be closer and/or further away from each other depending on the size of the fish 14, or else they may be retained a predetermined distance apart. Also, the side walls 18a and 18b may be situated parallel relative to each other or else they may be situated non-parallel relative to each other.

FIG. 2 also illustrates a bottom surface 20. The bottom surface 20 is located below the bottom ends 121 and 122 of the side clamping members 12a and 12b. The bottom ends 121 and 122 of the side clamping members 12a and 12b are preferably located near to but not touching the bottom surface 20, thereby permitting the bottom ends 121 and 122 of the side clamping members 12a and 12b to move without being impeded by the bottom surface 20. The bottom surface 20 includes an opening 24. The opening 24 is suitable for the insertion of a needle or other vaccine delivery device. The opening 24 may be a hole, a slot, or any other shape.

FIG. 2 also illustrates an upper clamping member 26. The upper clamping member 26 is adjustable in a vertical or a substantially vertical direction. The upper clamping member 26 has a downward-oriented surface 261 that is configured to contact the back of a fish. Advantageously, the surface 261 of the upper clamping member 26 has a V-shape, or some other shape that conforms to the shape of a fish's back, although any shape is possible. FIG. 2 illustrates the upper clamping member 26 in a relatively high position, e.g., adjusted for a large fish, while FIG. 3 illustrates the upper clamping member 26 in a relatively low position, e.g., adjusted for a small fish.

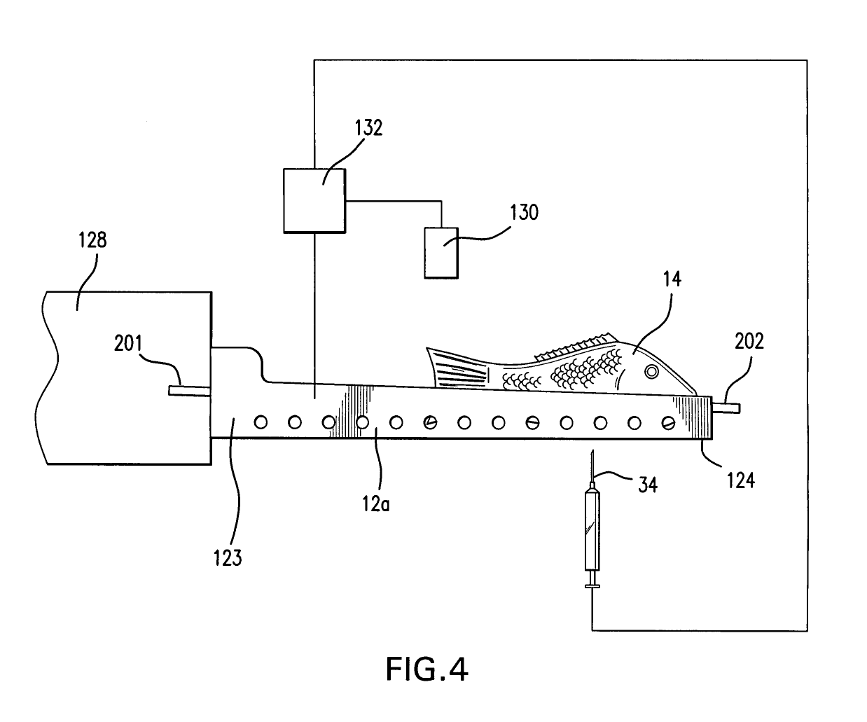

FIG. 4 is a side view that illustrates some of the components of the fish holding device 10, according to one embodiment of the present invention. Specifically, FIG. 4 illustrates a side view of the side clamping member 12b. The side clamping member 12b has a rear end 123 and a front end 124. Advantageously, the rear end 123 has a height which is greater than the height of the front end 124. In addition, the rear end 123 has a pivot arm 201 and the front end 124 has a pivot arm 202. Advantageously, the pivot arm 201 located at the rear end 123 is positioned at a height which is greater than the position of the pivot arm 202 located at the front end 124.

According to one embodiment, and as illustrated in FIG. 4, the fish holding device 10 may include or be situated after a tunnel 128 or the like. The tunnel 128 is preferably sized and shaped such that fish that enter the tunnel are caused to be lined up in a single file, e.g., one fish after another. Advantageously, the fish are oriented in a particular direction, e.g., head first and dorsal side facing up. Fish flow control systems that may be employed to separate and orient fish that are moving out of a fish containing vessel and into the fish holding device 10 of the present invention include, for instance, the fish flow control system of Applicant's co-pending patent application Ser. No. 10/444,757, which is incorporated by reference herein as fully as if set forth in its entirety.

According to one embodiment, the tunnel 128 that enters into the fish holding device 10 is adjustable so as to accommodate various different sizes and shapes of fish. Alternatively, the tunnel 128 that enters into the fish holding device 10 is a predetermined size, e.g., one that is selected in accordance with the size and shape of the fish to be handled. Whether adjustable or not, the tunnel 128 that enters into the fish holding device 10 is advantageously shaped and sized so as to prevent a fish from moving or swimming effectively. Furthermore, the tunnel 128 that enters into the fish holding device 10 is also shaped and sized so as to prevent a fish from curling or getting stuck. Rather, the fish are desirably moved through the tunnel 128 by the flow of water therethrough.

The fish holding device 10 may also include, in one embodiment of the present invention, a sensor 130. FIG. 4 illustrates a sensor 130 that is configured to sense when a fish is in position within the fish holding device 10. The sensor 130 may be connected to an actuation element 132, such that upon the sensor 130 sensing that a fish is in position within the fish holding device 10, the actuation element 132 functions to operate the fish holding device 10. The actuation element 132 may include a motor or any combination of mechanical or electrical components that functions to move the fish holding device 10 so as to hold a fish. Alternatively, it should be recognized that the fish holding device 10 may employ any method for determining that a fish is in position to be held, and may, in response to such a determination, be actuated manually by a user or by any other conceivable method.

In use, the fish holding device 10 of the present invention, in accordance with one embodiment thereof, may be employed as follows. The tunnel 128 that enters into the fish holding device 10 is adjusted so as to accommodate a particular size and shape of fish. A fish passes through the tunnel 128 and enters into the fish holding device 10. The side walls 18a and 18b of the fish holding device 10 have likewise preferably been adjusted in accordance with the size of the fish to be held. As the fish passes between the side walls 18a and 18b, the sensor 130 senses the presence of the fish and generates a signal to the actuation element 132.

The actuation element 132 receives the signal sent by the sensor 130 and actuates the fish holding device 10 by pivoting the side clamping members 12a and 12b about pivot points 20a and 20b. The side clamping members 12a and 12b engage opposite sides of the fish's belly. Specifically, the two side clamping members 12a and 12b firmly hold the fish 14 in place therebetween by providing inward pressure against the belly of the fish 14.

In addition, the actuation element 132 may actuate the fish holding device 10 by moving the upper clamping member 26 is a downward direction. The downward-oriented surface 261 of the upper clamping member 26 engages the back of the fish and is moved in a downward direction so as to gently but firmly push the fish 14 into a firmer engagement with the side clamping members 12a and 12b. The amount by which the upper clamping member 26 is moved downwardly may, in one embodiment, be a distance predetermined to push the fish 14 into a firmer engagement with the side clamping members 12a and 12b without harming the fish. Alternatively, the fish holding device 10 may employ sensors, e.g., pressure sensors or the like, that insure that the upper clamping member 26 is moved downwardly far enough to provide the firmer engagement of the fish's belly with the two side clamping members 12a and 12b but not so far as to harm the fish.

In addition, the downward movement of the upper clamping member 26 functions to push the central portion of the fish's belly into engagement with the bottom surface 20 of the fish holding device 10. Again, the amount by which the upper clamping member 26 is moved downwardly may, in one embodiment, be a distance predetermined to push the fish 14 into firm engagement with the bottom surface 20 of the fish holding device 10 without harming the fish. Alternatively, the fish holding device 10 may employ sensors, e.g., pressure sensors or the like, that insure that the upper clamping member 26 is moved downwardly far enough to provide a firm engagement of the fish's belly with the bottom surface 20 of the fish holding device 10 but not so far as to harm the fish.

With the fish 14 firmly held by the fish holding device 10, a needle 34 may be directed through the opening 24 of the bottom surface 24. The needle 34 may be actuated automatically, e.g., by an actuation element 132 and in response to a signal from the sensor 130 that a fish is in position within the fish holding device 10 and is firmly held therein. Alternatively, the needle 34 may be inserted manually, e.g., by a user who visually confirms that a fish is in position within the fish holding device 10 and is firmly held therein.

Of course, it should be recognized that many variations of the fish holding device 10 may be employed in accordance with the present invention. For instance, in one embodiment, the side clamping members 12a and 12b may be tapered in height in either direction or else may be un-tapered. Furthermore, the pivot points 20a and 20b of the side clamping members 12a and 12b may be higher at a rear end 123 of the side clamping members 12a and 12b relative to the front ends 124, may be lower at a rear end 123 of the side clamping members 12a and 12b relative to the front ends 124, or may be positioned at a same elevation at a rear end 123 of the side clamping members 12a and 12b relative to the front ends 124. Still further, the pivot points 20a and 20b of the side clamping members 12a and 12b may be farther apart from each other at a rear end 123 of the side clamping members 12a and 12b relative to the front ends 124, may be closer together at a rear end 123 of the side clamping members 12a and 12b relative to the front ends 124, or may be positioned at a same distance apart at a rear end 123 of the side clamping members 12a and 12b relative to the front ends 124.

It should also be understood that, in accordance with other embodiments of the present invention, the side clamping members 12a and 12b may have any variety of shapes. For instance, while the side clamping members 12a and 12b are illustrated in the Figures as being initially straight, e.g., before being deformed when pressed against a fish 14, when viewed from above, in other embodiments the side clamping members 14 may initially be curved, ribbed, or any other conceivable shape. Furthermore, while the side clamping members 12a and 12b are illustrated in the Figures as generally forming a V-shape, e.g., in the region where they are pressed against a fish 14, in other embodiments the side clamping members 14 may form any other conceivable shape, such as a U-shape or parallel to each other. Also, while the fish holding device 10 is illustrated in the figures as having two side clamping members 12a and 12b, in other embodiments a single side clamping members 12a or 12b may be employed.

Furthermore, while the side clamping members 12a and 12b are illustrated in the Figures as being pivotable, in other embodiments the side clamping members 14 may be static in position. Such an arrangement may be particularly advantageous for use in holding anesthetized fish. Also, while the side clamping members 12a and 12b are illustrated in the Figures as both being pivotable, in other embodiments a single side clamping members 12a or 12b may be pivotable while a second side clamping member 12a or 12b remains static.

The present invention, in accordance with various embodiments thereof, provides numerous advantages as compared to conventional fish holding devices. For example, the side clamping members 12a and 12b provide for a firm hold on the fish's belly without harming the fish 14. Furthermore, the downward pressure applied by the upper clamping member 26 onto the back of the fish 14 increases the firmness of the hold on the fish's belly and increases the firmness with which the fish's belly is pressed against the bottom surface 20. In this manner, the side clamping members 12a and 12b resist lateral movement of the fish's belly when the needle 34 is pressed against and penetrates the skin of the fish's belly. This is true regardless of the sharpness of the needle 34, the velocity with which the needle 34 moves, or the resistance of the fish's skin to be penetrated.

The arrangement of the side clamping members 12a and 12b may also provide additional advantages. For instance, FIG. 4 illustrates that each one of the side clamping members 12a and 12b has a pivot arm 201 located at its rear end 123 that is positioned higher than the pivot arm 202 located at the front end 124 of the clamping member. FIG. 2 illustrates, according to one embodiment of the present invention, an arrangement that may be found near to the rear end 123 of the side clamping members 12a and 12b, e.g., having the pivot point 20a and 20b at a relatively high elevation. The pivot points 20a and 20b at this rear end 123 of the side clamping members 12a and 12b may be the pivot arms 201. FIG. 3 on the other hand illustrates, according to one embodiment of the present invention, an arrangement that may be found near to the front end 124 of the side clamping members 12a and 12b, e.g., having the pivot point 20a and 20b at a relatively low elevation. The pivot points 20a and 20b at this rear end 123 of the side clamping members 12a and 12b may be the pivot arms 202. By having the side clamping members 12a and 12b pivot at a high elevation at their rear end 123 relative to their front end 124, the tail portion of the fish 14 is held at a higher position than the front portion of the fish. This helps keep the fish 14 upright in the fish holding device 10. Furthermore, the relatively low pivot point of the side clamping members 12a and 12b in the vicinity of the opening 24, e.g, the location at which the needle 34 will penetrate the skin of the fish, enables the side clamping members 12a and 12b to contact smaller fish at a steep enough angle to be effective. This arrangement also provides for sufficient clearance to allow the upper clamping member 26 to press down on a fish 14 without contacting the side clamping members 12a and 12b.

In one embodiment, and as shown in FIG. 4, the side clamping members 12a and 12b are tapered such that the height of the side clamping members 12a and 12b is greater adjacent to the rear end 123 relative to the height adjacent to the front end 124. In this embodiment, when the side clamping members 12a and 12b are actuated, the rear ends 123 of the side clamping members 12a and 12b contact each other first, e.g., before the front ends 124 of the side clamping members 12a and 12b contact each other. As the side clamping members 12a and 12b continue to rotate, the flexibility of the side clamping members 12a and 12b enable the rear ends 123 of the side clamping members 12a and 12b to be gradually squeezed together, thereby again assisting with keeping a fish 14 upright in the fish holding device 10. While the rear ends 123 of the side clamping members 12a and 12b are gradually squeezed together, the front ends 124 of the side clamping members 12a and 12b may remain slightly spaced apart, facilitating the V-shape in the front region of the fish holding device 10. Still further, since in this embodiment the side clamping members 12a and 12b contact at their rear ends 123 before contacting at their front ends 124, the side clamping members 12a and 12b more closely conform to the shape of a fish 14, wherein the fish 14 is larger near to its front end then to its rear or tail end.

Thus, the several aforementioned objects and advantages of the present invention are most effectively attained. Those skilled in the art will appreciate that numerous modifications of the exemplary example embodiments described hereinabove may be made without departing from the spirit and scope of the invention. Although various exemplary example embodiments of the present invention have been described and disclosed in detail herein, it should be understood that this invention is in no sense limited thereby and that its scope is to be determined by that of the appended claims.

What is claimed is:

1. A device for holding a fish comprising:
at least two side clamping members configure to engage opposite sides of a fish's belly region;
an upper clamping member configured to push downwardly on the back of the fish.

2. The device of claim 1, further comprising a pair of side walls, each of the two side clamping members attached to a respective one of the side walls.

3. The device of claim 2, wherein the side walls are adjustable.

4. The device of claim 2, wherein the side walls are parallel relative to each other.

5. The device of claim 2, wherein the side walls are non-parallel relative to each other.

6. The device of claim 2, wherein each side clamping member is pivotably attached to a respective side wall such that bottom edges of the side clamping members are pivotable towards each other.

7. The device of claim 6, wherein each side clamping member has a front end and a rear end.

8. The device of claim 7, wherein the front end of each side clamping member is higher than the rear end of the side clamping member.

9. The device of claim 7, wherein the rear end of each side clamping member is higher than the front end of the side clamping member.

10. The device of claim 7, wherein the side clamping members are tapered such that the rear end of each side clamping member is wider than the front end of the side clamping member.

11. The device of claim 7, wherein the side clamping members are tapered such that the front end of each side clamping member is wider than the rear end of the side clamping member.

12. The device of claim 7, wherein the side clamping members are flexible so as to conform to the shape of the fish.

13. The device of claim 7, wherein the side clamping members are arranged such that the rear ends of each side clamping member contact each other prior to the front ends of the side clamping member contacting each other.

14. The device of claim 7, wherein the side clamping members are arranged such that the rear ends of each side clamping member contact each other simultaneously to the front ends of the side clamping member contacting each other.

15. The device of claim 1, further comprising a bottom surface having at least one opening.

16. The device of claim 15, further comprising a needle.

17. The device of claim 16, wherein the needle is configured to be inserted through the opening in the bottom surface and through the skin of the fish.

18. The device of claim 1, further comprising an actuation element for actuating the needle to be inserted through the opening and to penetrate the skin of the fish.

19. The device of claim 1, further comprising a sensor for sensing when a fish is in position between the side clamping members.

20. The device of claim 19, further comprising an actuation element for actuating the side clamping members so as to hold a fish that is sensed to be in position between the side clamping members.

21. The device of claim 19, further comprising an actuation element for actuating the upper clamping member so as to press down on a fish that is sensed to be in position between the side clamping members.

22. The device of claim 1, wherein one of the side clamping members is pivotably attached to a side wall.

23. The device of claim 1, wherein the side clamping members form a substantially V-shape when pivoted relative to respective side walls.

24. The device of claim 1, wherein the side clamping members form a substantially U-shape when pivoted relative to respective side walls.

25. The device of claim 1, wherein the side clamping members are configured to hold a non-anesthetized fish.

26. The device of claim 1, wherein the side clamping members are static relative to respective side walls.

27. The device of claim 26, wherein the side clamping members are configured to hold an anesthetized fish.

28. The device of claim 1, wherein the device is configured to administer a vaccine.
